(19) United States
(12) Patent Application Publication
(10) Pub. No.: US 2012/0176288 A1
(43) Pub. Date: Jul. 12, 2012

(54) MAGNETIC DIELECTRIC ANTENNA

(76) Inventors: Kota Furuya, Tama-shi (JP); Hiroki Yoshioka, Kawasaki-shi (JP); Koki Sato, Sagamihara-shi (JP)

(21) Appl. No.: 13/499,156

(22) PCT Filed: Sep. 22, 2010
(86) PCT No.: PCT/JP2010/066374

§ 371 Date: Mar. 29, 2012

(30) Foreign Application Priority Data
Sep. 30, 2009 (JP) 2009-227342

(51) Int. Cl. H01Q 1/00

(52) U.S. Cl. 343/787

(57) ABSTRACT

The objective is realizing downsizing of an antenna, suppressing the decrease in radiation efficiency, and suppressing narrowing of band. A magnetic dielectric antenna 10 is provided with a L-shaped electrode 12 having a meander shape, and a magnetic dielectric body base portion 11 provided to cover at least a part of the electrode 12, wherein the electrode 12 comprises an electrode portion 12a arranged so that the extending direction of electrode portion 12a is parallel with a ground portion with a predetermined gap therefrom, and an electrode portion 12b connected to the electrode portion 12a.

### TECHNICAL FIELD

The present invention relates to a magnetic dielectric antenna.

### BACKGROUND ART

Antennas for wireless communication are known which are provided in electronic apparatuses. Examples of the electronic apparatuses include mobile apparatuses such as mobile phones, and antennas therefore have been required to be downsized.

Dielectric antennas are known as antennas capable of being downsized (for example, see Patent Literature 1). A dielectric antenna includes an electrode having, for example, a meandering shape and a dielectric base provided with the electrode. The effect of shortening the wavelength of a radio wave due to the relative permittivity of this base allows the antenna length to be shortened to downsize the dielectric antenna.

### CITATION LIST

### Patent Literature

Patent Literature 1: Japanese Patent Laid-Open Publication No. 2005-86418

### SUMMARY OF INVENTION

### Technical Problem

When a conventional dielectric antenna has a base of high permittivity material for downsizing, the antenna exhibits decreased radiation efficiency and a narrow band thereof.

It is an object of the present invention to downsize an antenna and to prevent a decrease in radiation efficiency and narrowing of a band.

### Solution to Problem

In order to solve the above problem, a magnetic dielectric antenna in accordance with the present invention includes an L-shaped meandering electrode and a magnetic dielectric base portion covering at least part of the electrode, and the electrode includes a first electrode portion disposed so as to extend in parallel to a ground portion with a predetermined interval and a second electrode portion connected to the first electrode portion.

Preferably, in the magnetic dielectric antenna, the base portion includes a first base portion having a thickness in the direction from the first electrode portion toward the ground portion, and the first base portion is disposed so as to have a predetermined interval between a bottom surface thereof and the ground portion.

Preferably, in the magnetic dielectric antenna, the first electrode portion is provided with a second base portion having a thickness in the direction opposite to the ground portion from the first electrode portion.

Preferably, in the magnetic dielectric antenna, the first base portion has a thickness equal to the thickness of the second base portion.

Preferably, in the magnetic dielectric antenna, the second base portion has a larger thickness than the thickness of the first base portion.

Preferably, in the magnetic dielectric antenna, the second base portion has a smaller thickness than the thickness of the first base portion.

Preferably, in the magnetic dielectric antenna, the ground portion is provided on a substrate, and the electrode is disposed so as to have a meandering surface orthogonal to a surface of the substrate.

Preferably, in the magnetic dielectric antenna, the ground portion is provided on a substrate, and the electrode is disposed such that the second electrode portion is orthogonal to a surface of the substrate.

### Advantageous Effects of Invention

The present invention can downsize an antenna and prevent a decrease in radiation efficiency and narrowing of a band.

### BRIEF DESCRIPTION OF DRAWINGS

FIG. 1 This is a perspective view illustrating a configuration of a magnetic dielectric antenna mounted on a substrate of the embodiment in accordance with the present invention.

FIG. 2 This is a perspective configuration of the magnetic dielectric antenna.

FIG. 3 This is a perspective view illustrating the magnetic dielectric antenna of FIG. 1 excluding a base portion.

FIG. 4 This is a perspective view illustrating a dielectric antenna mounted on a substrate.

FIG. 5 This is a diagram showing frequency characteristics of VSWR (voltage standing wave ratio) of the dielectric antenna and the magnetic dielectric antenna.

FIG. 6 This is a diagram showing frequency characteristics of radiation efficiency of the dielectric antenna and the magnetic dielectric antenna.

FIG. 7 This is a perspective configuration of a first magnetic dielectric antenna of a first variation.

FIG. 8 This is a perspective configuration of a second magnetic dielectric antenna of the first variation.

FIG. 9 This is a diagram showing frequency characteristics of VSWR of the magnetic dielectric antenna of the embodiment and the first and second magnetic dielectric antennas of the first variation.

FIG. 10 This is a diagram showing frequency characteristics of radiation efficiency of the magnetic dielectric antenna of the embodiment and the first and second magnetic dielectric antennas of the first variation.

FIG. 11 This is a perspective view illustrating a magnetic dielectric antenna mounted on a substrate of a second variation.

FIG. 12 This is a perspective view illustrating the magnetic dielectric antenna of FIG. 11 excluding a base portion.

### DESCRIPTION OF EMBODIMENT

An embodiment, a first variation, and a second variation in accordance with the present invention will now be described in detail sequentially with reference to the accompanying drawings. However, the scope of the present invention is not limited to examples shown in the drawings.

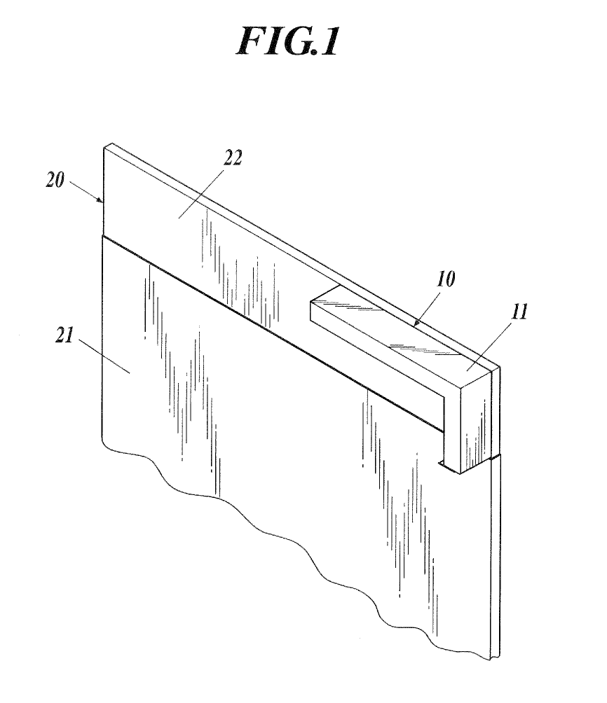

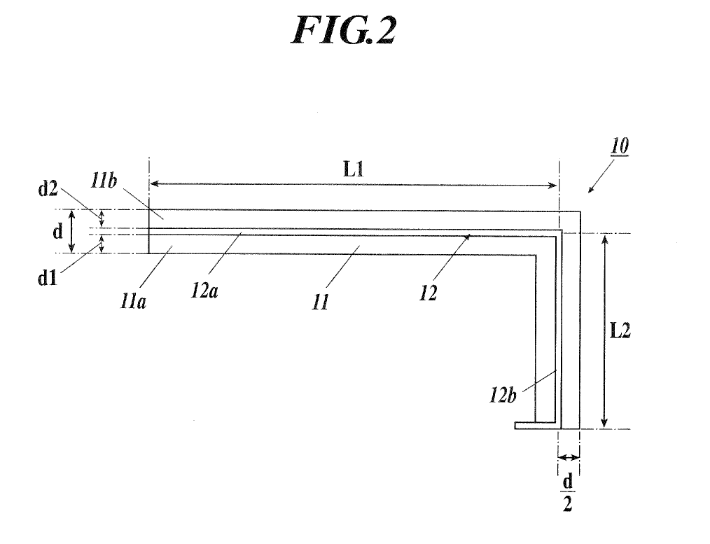

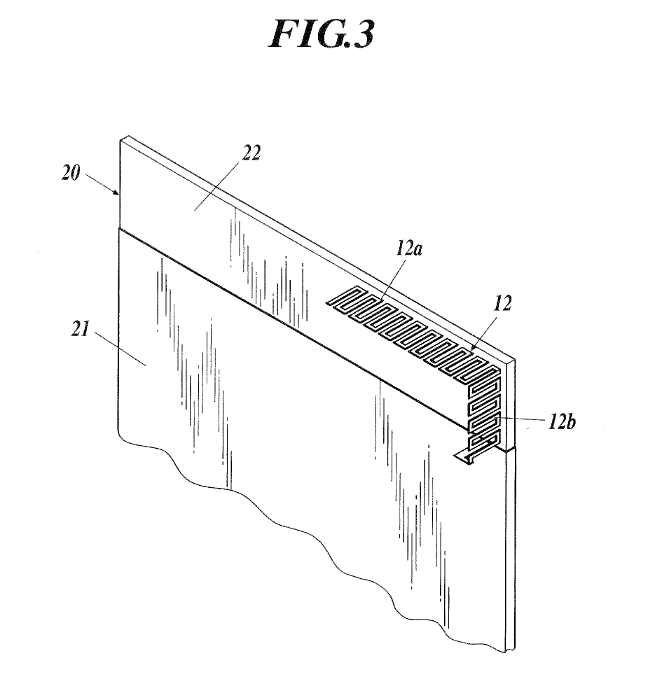

The embodiment in accordance with the present invention will be described with reference to FIGS. 1 to 6. First, a device configuration of a magnetic dielectric antenna 10 of the embodiment will be described with reference to FIGS. 1 to 3. FIG. 1 illustrates the magnetic dielectric antenna 10 mounted on a substrate 20. FIG. 2 illustrates a perspective configuration of the magnetic dielectric antenna 10. FIG. 3 illustrates the magnetic dielectric antenna 10 of FIG. 1 excluding a base portion 11.

The magnetic dielectric antenna 10 of the embodiment will be described as a wireless antenna having a resonant frequency of 700 [MHz] in accordance with a communication standard of LTE (Long Term Evolution). The present invention, however, should not be limited to this. The magnetic dielectric antenna 10 may be a wireless antenna in accordance with any other communication standard or having any other resonant frequency.

The magnetic dielectric antenna 10 is mounted on the substrate 20 as shown in FIG. 1. The substrate 20 is built in an apparatus such as a mobile phone or a PDA (personal digital assistant) which has a wireless communication function of LTE. The substrate 20 includes a ground portion 21 and a substrate portion 22. The ground portion 21 is composed of metal such as copper foil provided on an insulating main body of the substrate and is grounded. The substrate portion 22 is a part of an end of the insulating main body of the substrate where the magnetic dielectric antenna 10 is attached. The magnetic dielectric antenna 10 is an L-shaped antenna. The magnetic dielectric antenna 10 is also built in the above mentioned apparatus.

The magnetic dielectric antenna 10 includes the base portion 11 and an electrode 12 as an antenna element as shown in FIG. 2. The base portion 11 is provided around the electrode 12 and is composed of composite material of dielectric material and magnetic material. This composite material is composed of a mixture of a dielectric base of polypropylene or such like and magnetic particles of iron, hexagonal ferrite or such like. The base portion 11 has relative magnetic permeability of, for example, 4 to 6.

The electrode 12 is a metallic L-shaped bent electrode embedded inside the base portion 11 as shown in FIG. 2. The electrode 12 is L-shaped in order to reduce the height of the magnetic dielectric antenna 10.

The electrode 12 also includes an electrode portion 12a and an electrode portion 12b. The electrode portion 12a is disposed so as to extend in parallel to the ground portion 21 with a predetermined interval therebetween. The electrode portion 12b is connected to the electrode portion 12a and is disposed so as to extend orthogonal to the ground portion 21.

The length of the electrode portion 12a in its extending direction is defined as a length L1. The length of the electrode portion 12b in its extending direction is defined as a length L2. The length of the base portion 11 in the direction orthogonal to the extending directions of the electrode portion 12a and the electrode portion 12b on a plane of FIG. 2 is defined as a thickness d. The electrode portions 12a and 12b resides at a location of the thickness of d/2 of the base portion 11. L1 is longer than L2 in this embodiment. The present invention however is not limited to this, and L1 may be equal to or shorter than L2.

The base portion 11 also includes a base portion 11a as a first base portion and a base portion 11b as a second base portion. The base portion 11a has a thickness in the direction from the electrode portion 12a toward the ground portion 21. The base portion 11a is disposed so as to have a predetermined interval between its bottom surface and the ground portion 21. The base portion 11b has a thickness in the direction opposite to the ground portion 21 from the electrode portion 12a. The thickness of the base portion 11a is defined as a thickness d1, and the thickness of the base portion 11b as a thickness d2. The base portion 11a and the base portion 11b have a relationship of d1=d2.

The electrode 12 has a meandering shape as shown in FIG. 3. The reason for the meandering shape of the electrode 12 is to increase the antenna length in limited space inside the apparatus.

The electrode 12 is disposed inside the base portion 11 to cause an effect of shortening the wavelength of a radio wave as described by the following numerical expression (1).

$$\begin{matrix} [ Numerical Expression 1 ] & \\ {λ}_{r} = \frac{λ}{\sqrt{{ɛ}_{r} \cdot {μ}_{r}}} & ( 1 )\end{matrix}$$

Here, λr is the wavelength of a radio wave in a magnetic dielectric antenna, λ is the wavelength of a radio wave in a free space, ∈r is relative permittivity of a base portion of magnetic dielectric material, and pr is relative magnetic permeability of a base body of magnetic dielectric material.

Expression (1) demonstrates that the base portion 11 can decrease the wavelength of a radio wave in the magnetic dielectric antenna 10 and thus can shorten the antenna length of the electrode 12.

The electrode 12 is also disposed such that the lateral direction of a meandering surface (direction orthogonal to the extending direction of the electrode 12) is orthogonal to a surface of the substrate 20. The base portion 11 is not provided over the entire surface between the electrode 12 and the ground portion 21. This configuration is implemented to suppress the electrostatic capacitance between the electrode 12 and the ground portion 21.

The electrode 12 is disposed at the center in the thickness direction of the base portion 11. In other words, the electrode 12 is disposed at a length of d/2 in the thickness direction from a surface surrounding the base portion 11. The electrode 12 is disposed at the center in the thickness direction of the base portion 11 in order to utilize a magnetic field generated around the electrode 12.

Connector pins (not shown in the drawing) for supplying an antenna current are provided at the substrate portion 22. The connector pins are connected to a feeder portion for feeding the antenna current through a transmission-line pattern (not shown in the drawing) formed on the substrate 20 (the ground portion 21) or a coaxial cable (not shown in the drawing). The connector pins are connected to an end of the electrode 12 (the electrode portion 12b), and the antenna current is fed through the connector pins to the electrode 12.

The magnetic dielectric antenna 10 is manufactured by, for example, an integral molding process of casting magnetic dielectric material for the base portion 11 into a fixed mold containing the electrode 12. This integral molding process is preferable since the base portion 11 is formed also in the spaces of a meandering shape. The magnetic dielectric antenna 10 may be manufactured in other ways of, for example, sandwiching the electrode 12 between two base portions.

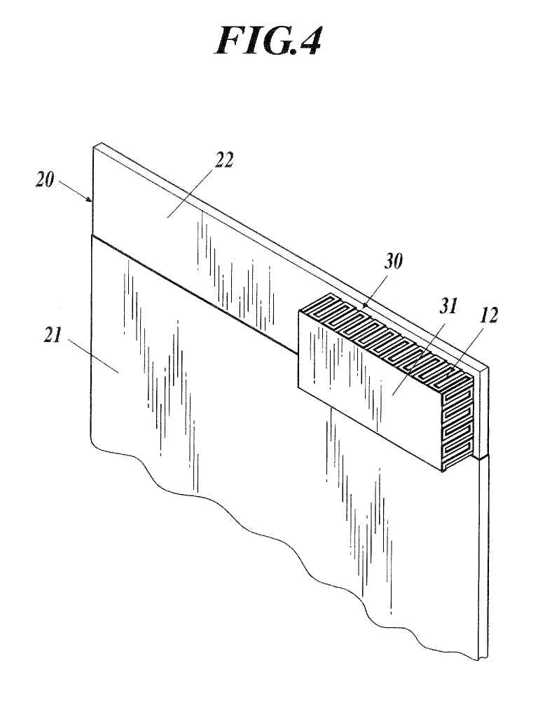

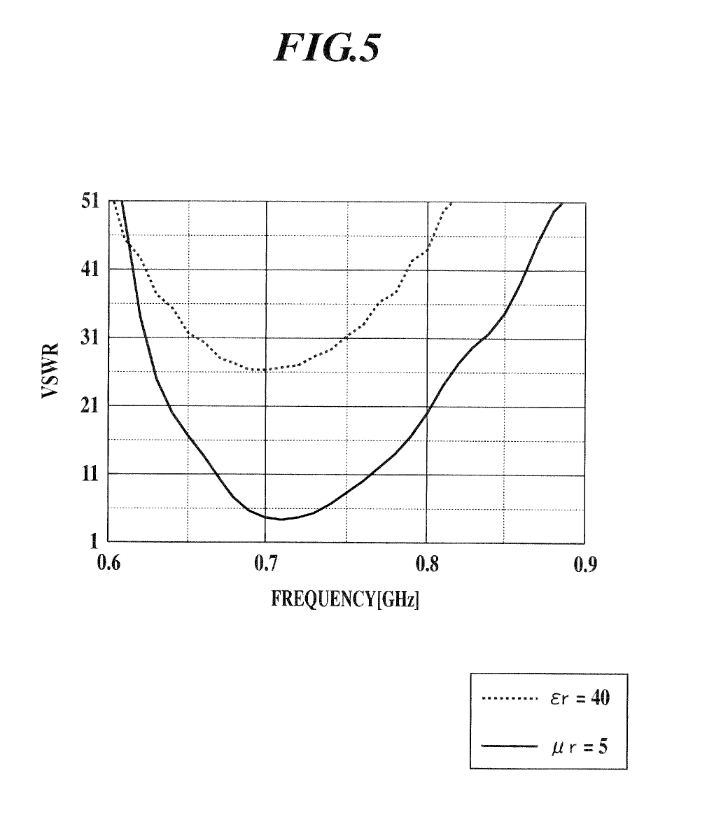

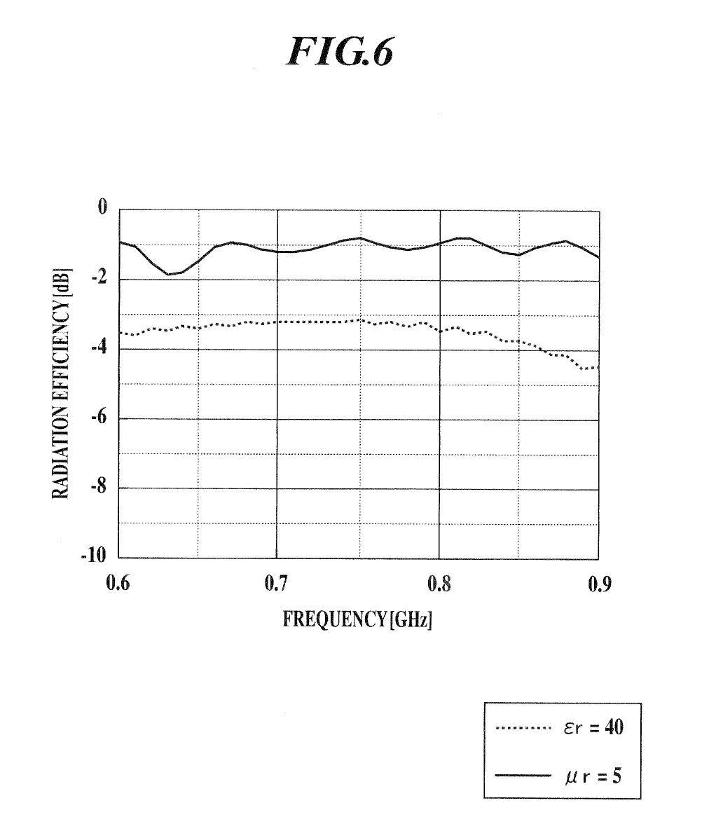

Next, operational characteristics of the magnetic dielectric antenna 10 will be described with reference to FIGS. 4 to 6. FIG. 4 illustrates a dielectric antenna 30 mounted on the substrate 20. FIG. 5 shows frequency characteristics of VSWR of the dielectric antenna 30 and the magnetic dielectric antenna 10. FIG. 6 shows frequency characteristics of radiation efficiency of the dielectric antenna 30 and the magnetic dielectric antenna 10.

The dielectric antenna 30 to be compared with the magnetic dielectric antenna 10 will now be described with reference to FIG. 4. The dielectric antenna 30 is mounted on a substrate portion 22 of a substrate 20.

The dielectric antenna 30 includes a base portion 31 and an electrode 12. This electrode 12 is the same electrode portion as that of the magnetic dielectric antenna 10. The base portion 31 is composed of dielectric material and is a rectangular-parallelepiped base portion provided inside the electrode 12 (near the ground portion 21). The base portion 31 is provided inside the electrode 12 since the electric field of the electrode 12 acts toward the ground portion 21. In contrast to that, the magnetic field of the electrode 12 acts around the electrode 12.

For example, the base portion 31 of the dielectric antenna 30 has relative permittivity ∈r of 40, and the base portion 11 of the magnetic dielectric antenna 10 has relative magnetic permeability μr of 5. Frequency characteristics of VSWR of the dielectric antenna 30 and the magnetic dielectric antenna 10 are calculated by simulation and the characteristics illustrated in FIG. 5 are obtained. However, only the relative magnetic permeability of the base portion 11 is employed in this simulation in order to observe the effect of the relative magnetic permeability on the base portion 11. The VSWR of the dielectric antenna 30 and the magnetic dielectric antenna 10 has the lowest value at a resonant frequency of 700 [MHz] as shown in FIG. 5. The magnetic dielectric antenna 10 was found to have a wider band than that of the dielectric antenna 30.

Similarly, frequency characteristics of radiation efficiency of the dielectric antenna 30 and the magnetic dielectric antenna 10 are calculated by simulation and the characteristics illustrated in FIG. 6 are obtained. The radiation efficiency is the ratio of the radiated power to the power inputted to the antenna and does not depend on the value of VSWR. The magnetic dielectric antenna 10 was found to have a higher value of radiation efficiency than that of the dielectric antenna 30 according to FIG. 6.

As described above, the magnetic dielectric antenna 10 in accordance with this embodiment includes the meandering electrode 12 and the magnetic dielectric base portion 11 disposed around the electrode 12. The meandering shape of the electrode 12 allows the antenna length to be shortened, use of the relative permittivity and the relative magnetic permeability of the base portion 11 allows the effect of shortening the wavelength to be enhanced to downsize the magnetic dielectric antenna 10A and to prevent a decrease in the radiation efficiency and narrowing of the band caused by high permittivity.

The electrode 12 is L-shaped. Thereby, the magnetic dielectric antenna 10 can be further downsized for installation in a limited space.

The electrode portion 12a of the electrode 12 is disposed so as to extend in parallel to the ground portion 21 with a predetermined interval therebetween. Thereby, the electrostatic capacitance between the electrode 12 and the ground portion 21 can be suppressed to further prevent the radiation efficiency of the magnetic dielectric antenna 10 from decreasing.

Unlike the dielectric antenna 30 including the base portion 31 occupying the entire area between the electrode 12 and the ground portion 21, the magnetic dielectric antenna 10 includes the base portion 11 covering the electrode 12. Thereby, the electrostatic capacitance between the electrode 12 and the ground portion 21 can be suppressed to further prevent the radiation efficiency of the magnetic dielectric antenna 10 from decreasing.

The electrode 12 is disposed so as to have a meandering surface orthogonal to a surface of the substrate 20. Thereby, the electrostatic capacitance between the electrode 12 and the ground portion 21 can be suppressed to further prevent the radiation efficiency of the magnetic dielectric antenna 10 from decreasing.

The magnetic dielectric antenna 10 includes the base portion 11a having a thickness d1 equal to the thickness d2 of the base portion 11b. Thereby, the effect of the permittivity can be enhanced to downsize the magnetic dielectric antenna 10, and the electrostatic capacitance between the electrode 12 and the ground portion 21 can be suppressed to further prevent the radiation efficiency of the magnetic dielectric antenna 10 from decreasing.

### (First Variation)

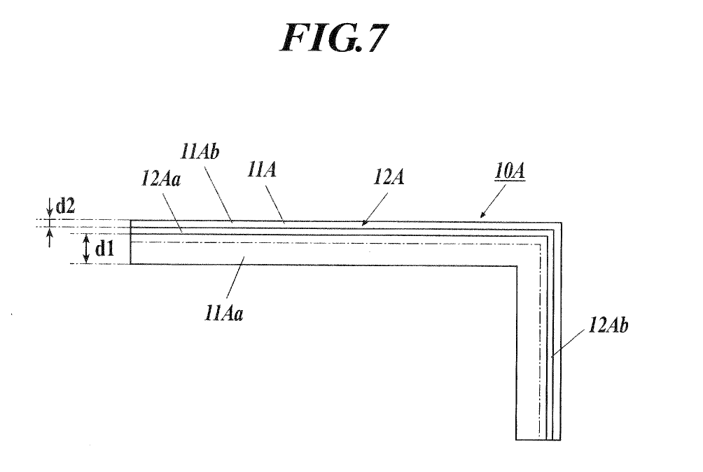

A first variation of the preceding embodiment will be described with reference to FIGS. 7 to 10. In the preceding embodiment, the magnetic dielectric antenna 10 includes the electrode 12 disposed at the center of the thickness of the base portion 11. In contrast to that, a magnetic dielectric antenna of this variation is shifted from the center of the thickness of a base portion 11.

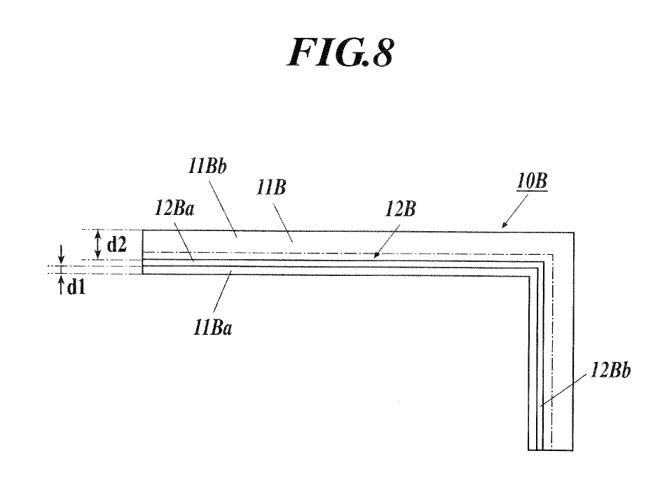

The device configuration of this variation will now be described with reference to FIGS. 7 and 8. FIG. 7 illustrates a perspective configuration of the magnetic dielectric antenna 10A of this variation. FIG. 8 illustrates a perspective configuration of another magnetic dielectric antenna 10B of this variation. The central lines of a base portion 11A and a base portion 11B in the thickness direction are indicated by chain lines in FIGS. 7 and 8, respectively.

The magnetic dielectric antenna 10A includes the base portion 11A and an electrode 12A as shown in FIG. 7. The magnetic dielectric antenna 10A is mounted on a substrate portion 22 of a substrate 20, like the magnetic dielectric antenna 10. The base portion 11A has a similar configuration to the base portion 11.

The electrode 12A is a metallic L-shaped bent electrode embedded inside the base portion 11A. The electrode 12A includes an electrode portion 12Aa similar to the electrode portion 12a and an electrode portion 12Ab similar to the electrode portion 12b. The electrode portion 12Aa is shifted outward (opposite to the ground portion 21) from the center in the thickness direction of the base portion 11A. The electrode 12Ab is shifted outward (rightward in FIG. 7) from the center of the base portion 11A.

The base portion 11A also includes a base portion 11Aa as a first base portion and a base portion 11Ab as a second base portion similarly to the base portion 11. The base portion 11Aa has a thickness in the direction from the electrode portion 12Aa toward the ground portion 21. The base portion 11b has a thickness in the direction opposite to the ground portion 21 from the electrode portion 12Aa. The thickness of the base portion 11Aa is defined as a thickness d1, and the thickness of the base portion 11Ab as a thickness d2. The base portion 11Aa and the base portion 11Ab have a relationship of d1>d2.

The magnetic dielectric antenna 10B includes the base portion 11B and an electrode 12B as shown in FIG. 8. The magnetic dielectric antenna 10B is mounted on a substrate portion 22 of a substrate 20 similarly to the magnetic dielectric antenna 10. The base portion 11B has a similar configuration to the base portion 11.

The electrode 12B is a metallic L-shaped bent electrode embedded inside the base portion 11B. The electrode 12B includes an electrode portion 12Ba similar to the electrode portion 12a and an electrode portion 12Bb similar to the electrode portion 12b. The electrode portion 12Ba is shifted inward (toward the ground portion 21) from the center in the thickness direction of the base portion 11B. The electrode portion 12Bb is shifted inward (leftward in FIG. 8) from the center of the base portion 11B.

The base portion 11B includes a base portion 11Ba as a first base portion and a base portion 11Bb as a second base portion like the base portion 11. The base portion 11Ba has a thickness in the direction from the electrode portion 12Ba toward the ground portion 21. The base portion 11Bb has a thickness in the direction opposite to the ground portion 21 from the electrode portion 12Ba. The thickness of the base portion 11Ba is defined as a thickness d1, and the thickness of the base portion 11Bb as a thickness d2. The base portion 11Ba and the base portion 11Bb have a relationship of d1<d2.

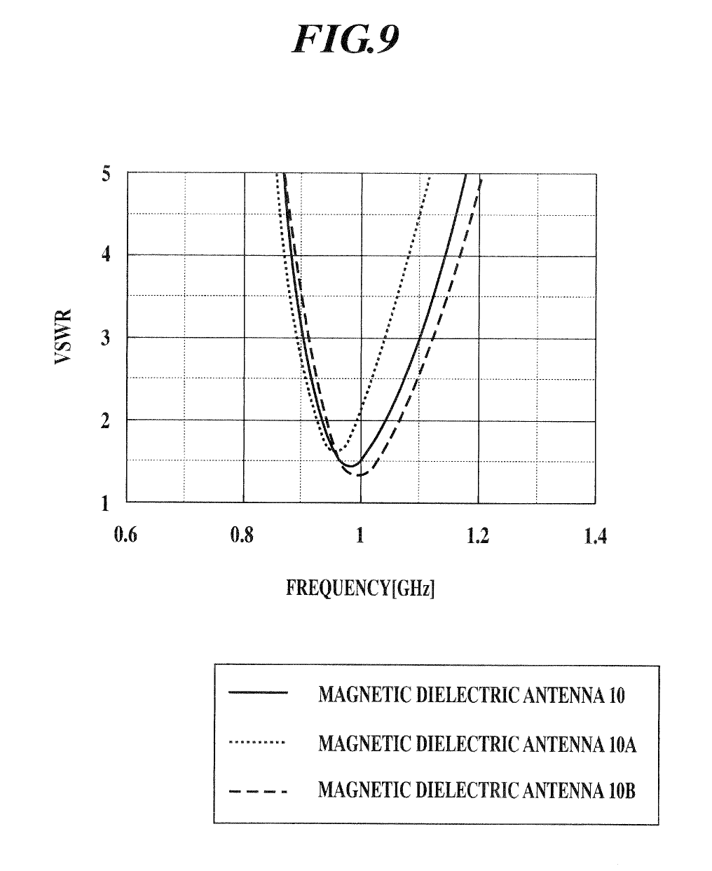

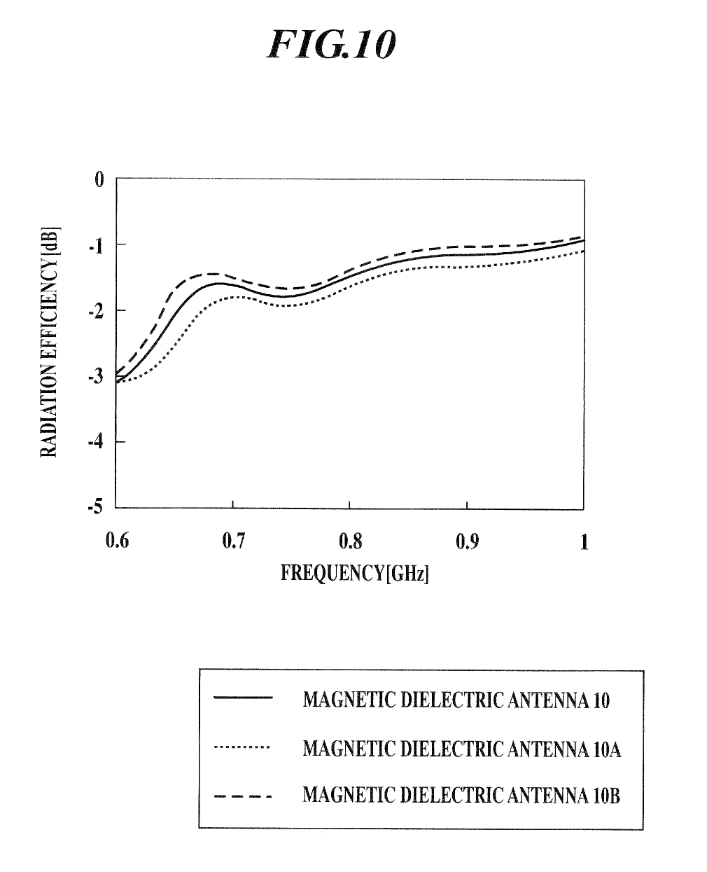

Next, characteristics of the magnetic dielectric antennas 10A and 10B will be described with reference to FIGS. 9 and 10. FIG. 9 shows frequency characteristics of VSWR of the magnetic dielectric antennas 10, 10A, and 10B. FIG. 10 shows frequency characteristics of radiation efficiency of the magnetic dielectric antennas 10, 10A, and 10B.

The magnetic dielectric antenna 10 is used for comparison. In this example, the base portions 11, 11A, and 11B each have a thickness of 2 [mm]. The electrode 12 is disposed at a position (at the center) 1[mm] distant from an end surface of the base portion 11 in the thickness direction. The electrode 12A is disposed at a position 0.5[mm] outward from the center in the thickness direction of the base portion 11A. The electrode 12B is disposed at a position 0.5[mm] inward from the center in the thickness direction of the base portion 11B. The resonant frequency of the magnetic dielectric antenna 10 is set to 1 [GHz], and the magnetic dielectric antennas 10A and 10B each have the same external shape as that of the magnetic dielectric antenna 10. The relative permittivity of the base portions 11, 11A, and 11B is set to the same value. The relative magnetic permeability of the base portions 11, 11A, and 11B is set to the same value.

The magnetic dielectric antenna 10A has a lower resonant frequency than that of the magnetic dielectric antenna 10 as shown in FIG. 9. The reason is that the effect of shortening the wavelength of the magnetic dielectric antenna 10A is also enhanced since the effect of the permittivity of the magnetic dielectric antenna 10A is enhanced in comparison with the magnetic dielectric antenna 10. Thereby, the magnetic dielectric antenna 10A having the same resonant frequency as that of the magnetic dielectric antenna 10 can be further downsized compared to the magnetic dielectric antenna 10.

The magnetic dielectric antenna 10B has higher radiation efficiency than that of the magnetic dielectric antenna 10 as shown in FIG. 10. The reason is that the electrostatic capacitance of the magnetic dielectric antenna 10B is suppressed since the thickness of the base portion 11B between the electrode 12B and the ground portion 21 of the magnetic dielectric antenna 10A is decreased in comparison with the magnetic dielectric antenna 10.

As described above, the magnetic dielectric antenna 10A in accordance with this variation provides similar advantageous effects to the magnetic dielectric antenna 10. Additionally, the magnetic dielectric antenna 10A includes the base portion 11Aa having a larger thickness d1 than the thickness d2 of the base portion 11Ab. Thereby, the effect of the permittivity can be enhanced to further downsize the magnetic dielectric antenna 10A compared to the magnetic dielectric antenna 10.

The magnetic dielectric antenna 10B in accordance with this variation also provides similar advantageous effects to the magnetic dielectric antenna 10. Additionally, the magnetic dielectric antenna 10B includes the base portion 11Ba having a smaller thickness d1 than the thickness d2 of the base portion 11Bb. Thereby, the electrostatic capacitance between the electrode 12B and the ground portion 21 can be suppressed to further prevent the radiation efficiency of the magnetic dielectric antenna 10B from decreasing compared to that of the magnetic dielectric antenna 10.

### (Second Variation)

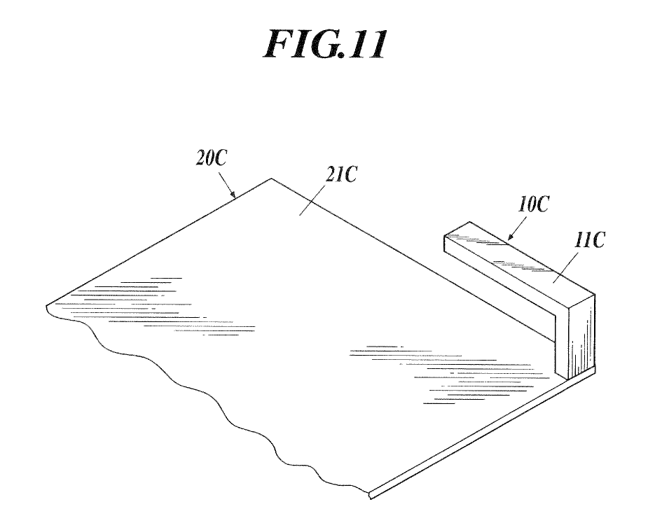

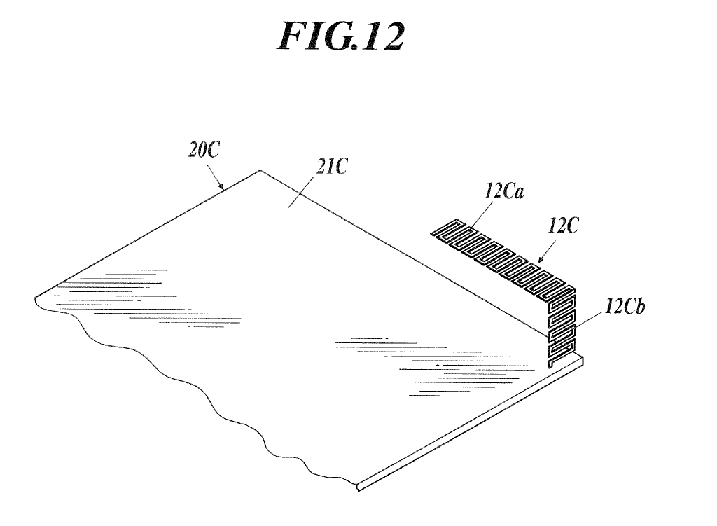

A second variation of the preceding embodiment will be described with reference to FIGS. 11 and 12. In the preceding embodiment, the magnetic dielectric antenna 10 is mounted on the substrate portion 22 such that the lateral direction of the meandering surface of the electrode 12 is orthogonal to the surface of the substrate 20. In this variation, a magnetic dielectric antenna is mounted on a substrate such that an extending direction of an electrode is orthogonal to a surface of the substrate.

The device configuration of this variation will be described with reference to FIGS. 11 and 12. FIG. 11 illustrates the magnetic dielectric antenna 10C mounted on the substrate 20C. FIG. 12 illustrates the magnetic dielectric antenna 10C of FIG. 11 excluding a base portion 11C.

The magnetic dielectric antenna 10C in this variation is mounted on the substrate 20C as shown in FIGS. 11 and 12. The substrate 20C includes a ground portion 21C extending to an end thereof similarly to the ground portion 21. The magnetic dielectric antenna 10C includes a base portion 11C similar to the base portion 11 and an electrode 12C similar to the electrode 12. The electrode 12C includes an electrode portion 12Ca similar to the electrode portion 12a and an electrode portion 12Cb similar to the electrode portion 12b.

The electrode portion 12Ca is disposed so as to extend in parallel to the ground portion 21C with a predetermined interval therebetween. The electrode portion 12Ca is also disposed so as to have a meandering surface in parallel to a surface of the ground portion 21C. The electrode portion 12Cb is disposed so as to extend orthogonal to the ground portion 21C.

As described above, the magnetic dielectric antenna 10C in accordance with this variation provides similar advantageous effects to the magnetic dielectric antenna 10. In particular, the electrode portion 12Ca of the electrode 12C extends in parallel to the ground portion 21C with a predetermined interval therebetween. Thereby, the electrostatic capacitance between the electrode 12C and the ground portion 21C can be suppressed to further prevent the radiation efficiency of the magnetic dielectric antenna 10C from decreasing.

Additionally, the electrode portion 12Cb of the electrode 12C extends orthogonal to the ground portion 21C. This can decrease the area for mounting the magnetic dielectric antenna 10C.

The preceding embodiment and the variations have been described as examples of the magnetic dielectric antennas in accordance with the present invention, which is not limited to these examples.

For example, at least two of the preceding embodiment and the variations may be properly combined. For example, the substrate 20C in the second variation may include a ground portion and a substrate portion. In this configuration, the magnetic dielectric antenna 10C (the electrode portion 12Cb) is mounted on the substrate portion of the substrate 20C.

Alternatively, at least part of the electrodes 12, 12A, 12B, and 12C may be covered with a base portion.

Other details of the configurations and operations of the magnetic dielectric antennas 10, 10A, 10B, and 10C in the preceding embodiment and the variations can also be properly modified without departing from the scope of the present invention.

### INDUSTRIAL APPLICABILITY

As described above, the magnetic dielectric antennas in accordance with the present invention are suitable for wireless communication such as LTE.

### DESCRIPTION OF REFERENCE NUMERALS

10, 10A, 10B, 10C magnetic dielectric antenna
11, 11a, 11b, 11A, 11Aa, 11Ab, 11B, 11Ba, 11Bb, 11C base portion
12, 12A, 12B, 12C electrode
12a, 12Aa, 12Ba, 12Ca electrode portion
12b, 12Ab, 12Bb, 12Cb electrode portion
20, 20C substrate
21, 21C ground portion
22 substrate portion
30 dielectric antenna
31 base portion

1. A magnetic dielectric antenna comprising:
an L-shaped meandering electrode; and
a magnetic dielectric base portion covering at least part of the electrode,
wherein the electrode includes:
a first electrode portion disposed so as to extend in parallel to a ground portion with a predetermined interval therebetween, and
a second electrode portion connected to the first electrode portion.

2. The magnetic dielectric antenna according to claim 1, wherein the base portion includes a first base portion having a thickness in a direction from the first electrode portion toward the ground portion, and the first base portion is disposed so as to have a predetermined interval between a bottom surface thereof and the ground portion.

3. The magnetic dielectric antenna according to claim 2, wherein the first electrode portion is provided with a second base portion having a thickness in the direction from the first electrode portion opposite to the ground portion.

4. The magnetic dielectric antenna according to claim 3, wherein the thickness of the first base portion is equal to the thickness of the second base portion.

5. The magnetic dielectric antenna according to claim 3, wherein the thickness of the second base portion is larger than the thickness of the first base portion.

6. The magnetic dielectric antenna according to claim 3, wherein the thickness of the second base portion is smaller than the thickness of the first base portion.

7. The magnetic dielectric antenna according to claim 1,
wherein the ground portion is provided on a substrate, and
the electrode is disposed so as to have a meandering surface orthogonal to a surface of the substrate.

8. The magnetic dielectric antenna according to claim 1,
wherein the ground portion is provided on a substrate, and
the electrode is disposed such that the second electrode portion is orthogonal to a surface of the substrate.

9. The magnetic dielectric antenna according to claim 2,
wherein the ground portion is provided on a substrate, and
the electrode is disposed such that the second electrode portion is orthogonal to a surface of the substrate.

10. The magnetic dielectric antenna according to claim 3,
wherein the ground portion is provided on a substrate, and
the electrode is disposed such that the second electrode portion is orthogonal to a surface of the substrate.

11. The magnetic dielectric antenna according to claim 4,
wherein the ground portion is provided on a substrate, and
the electrode is disposed such that the second electrode portion is orthogonal to a surface of the substrate.

12. The magnetic dielectric antenna according to claim 5,
wherein the ground portion is provided on a substrate, and
the electrode is disposed such that the second electrode portion is orthogonal to a surface of the substrate.

13. The magnetic dielectric antenna according to claim 6,
wherein the ground portion is provided on a substrate, and
the electrode is disposed such that the second electrode portion is orthogonal to a surface of the substrate.

14. The magnetic dielectric antenna according to claim 2,
wherein the ground portion is provided on a substrate, and
the electrode is disposed so as to have a meandering surface orthogonal to a surface of the substrate.

15. The magnetic dielectric antenna according to claim 3,
wherein the ground portion is provided on a substrate, and
the electrode is disposed so as to have a meandering surface orthogonal to a surface of the substrate.

16. The magnetic dielectric antenna according to claim 4,
wherein the ground portion is provided on a substrate, and
the electrode is disposed so as to have a meandering surface orthogonal to a surface of the substrate.

17. The magnetic dielectric antenna according to claim 5,
wherein the ground portion is provided on a substrate, and
the electrode is disposed so as to have a meandering surface orthogonal to a surface of the substrate.

18. The magnetic dielectric antenna according to claim 6,
wherein the ground portion is provided on a substrate, and
the electrode is disposed so as to have a meandering surface orthogonal to a surface of the substrate.
